(19) United States
(12) Patent Application Publication
(10) Pub. No.: US 2009/0286588 A1
(43) Pub. Date: Nov. 19, 2009

(54) Magnified symbol feature for gaming devices

(75) Inventor: Kathleen Nylund Jackson, Scituate, MA (US)

Correspondence Address: Precedent Gaming, Inc., 51 Williamsburg Lane, Scituate, MA, 02066, US

(73) Assignee: Precedent Gaming, Incorporated

(21) Appl. No.: 12/291,078

(22) Filed: Nov. 6, 2008

Related U.S. Application Data
(60) Provisional application No. 61/002,336, filed on Nov. 8, 2007.

(51) Int. Cl. A63F 9/24; A63F 13/00

(52) U.S. Cl. 463/20; 463/30

(57) ABSTRACT

A method and apparatus for a gaming machine is disclosed. A slot machine processor and a video monitor screen are provided on which symbols may be provided for use in a video slot game. The player makes a wager to play the underlying game. A first array of symbols is displayed in rows and columns and thereafter a feature opportunity may also be randomly, non-randomly or pseudo-randomly displayed. The feature comprises a special indicium that is displayed over one of the symbols in the initial array. Preferably the special indicium is a graphic representation of a magnifying glass. The magnifying glass enlarges the selected symbol uniformly along an x and y axis by at least 2×, in effect resulting in at least 4 same symbols being arranged in a 2-row by 2-column format. The same symbols replace the underlying symbols in the initial array and the resultant final symbol display is then analyzed by the machine processor, with any prizes for winning symbol combinations being awarded according to a predetermined paytable.

### RELATED APPLICATION DATA

This Application claims priority from U.S. Provisional Patent Application No. 61/002,336, filed Nov. 8, 2007, and having the Title MAGNIFIED SYMBOL FEATURE FOR GAMING DEVICES.

### BACKGROUND OF THE INVENTION

1. Field of the Invention

The present invention relates to a video slot symbol game suitable for use in casinos and other gaming enterprises. The invention further relates to video gaming play that provides a feature that randomly or pseudo-randomly enlarges a symbol in order to enhance the chance of winning.

2. Background of the Art

Gaming machines, whether providing video poker or slot games, have grown exponentially in numbers in the last twenty years, as have the revenues generated by such devices. It is estimated that more than 75% of any casino's revenue is now provided by gaming machines as opposed to table games.

In the gaming industry, there is a continuous need for innovative game features that will attract new players as well as keep regular players amused and therefore willing to continue playing the game. Since in virtually every casino game there is a house advantage, the longer a player remains playing at a machine, the larger the casino's profit. And also since it is well recognized in the industry that players tend to easily tire of particular games, manufacturers must constantly develop new game features to stimulate player interest.

The majority of today's slot machines are video slots, particularly 5-reel×3-row multiple payline video slots. Especially in the last decade, these multiline machine games have been augmented by bonus features or games that are particularly popular with the gaming public. Bonus games, “free spin” features, and multipliers add excitement and the opportunity for more lucrative pays, thereby increasing player interest.

Certain prior art has attempted to enhance the known video slot machine choices. Some inventive methods of play allow the player to select particular symbols or reels to respin, either before or after a basic wager. Other methods require a triggering mechanism that allows for the play of a bonus event wherein either the player or the microprocessor randomly or non-randomly selects symbols for rearrangement. Still other methods require an additional side bet that provides the opportunity to receive random bonus events or that provides the player with a higher percentage of achieving special-payout outcomes.

PCT Application No. PCT/AU99/01059, entitled “Player Information Delivery” discloses a video slot game in which an animated character occasionally randomly appears and awards a player a variable random bonus prize. The occurrence of the animated character is weighted by the desired hit rate of the feature and is dependent upon the player's bet and may or may not be dependent upon the size and type of the player's bet.

U.S. Pat. No. 7,192,345 (Muir, et al.) describes a gaming machine wherein during the playing of a first game, symbols related to the first game are displayed on the display. When a trigger condition occurs, a feature game is commenced in which an arrangement of at least some of the symbols of the first game are incorporated as part of a larger image which comprises an image of the feature game, the at least some symbols of the first game contributing to an outcome of the feature game.

U.S. Pat. No. 7,014,559 (Fong) discloses a gaming machine wherein a plurality of symbols is randomly selected and displayed on a display such that if a winning combination results, the machine pays a prize. Upon the occurrence of a predetermined triggering event, a bonus symbol is generated which is displayed in a first display position and, thereafter in at least one other display position. When the bonus symbol moves from a preceding display position, a residual symbol remains at the preceding display position and, when the bonus symbol appears at a subsequent display position, both the original bonus symbol and the residual bonus symbol operate as substitute symbols in their display positions.

U.S. Pat. No. 6,875,106 (Weiss, et al.) teaches a method and apparatus for a gaming device in which a player is awarded outright for a winning combination and is eligible for a reward if the displayed outcome can be manipulated by the gaming device to produce a winning combination. A special bar symbol can be coupled with a certain bar subset of the universe of symbols to initiate a further award, perhaps coupled with a multiplier. Preferably, a bonus is provided which includes overlapping exhibitors such as wheels having a sector defining the overlap indicating a bonus element which is placed on an array. A series of elements on the array, when forming a pattern which is recognized by the game results in added credits.

U.S. Pat. No. 6,855,054 (White, et al.) describes methods of playing games of chance and gaming devices and systems comprising a display of a plurality of symbols where at least one symbol may be interchanged with another symbol of the plurality of symbols. After a combination of symbols is randomly generated and the results are displayed to a player, the player may have the opportunity to interchange at least one displayed symbol with another symbol in order to configure a more advantageous symbol arrangement, and may be conditioned on placing an additional or side bet. Interchangeable symbols are described as encompassing the transposition of two or more symbols, removal and replacement of symbols, movement of symbols, alone or in combination with adjacent symbols, and combinations thereof.

U.S. Pat. No. 6,634,941 (Olive) discloses a gaming machine wherein a random event is caused to be displayed on a display. If a predefined winning event results, the machine awards a prize. When a secondary game, following a base game, is completed, a special symbol appears at at least one symbol position of the secondary game. The special symbol replaces, at least temporarily, an underlying symbol at the symbol position to contribute, if applicable, to a prize winning event.

U.S. Pat. No. 6,251,013 (Bennett) describes a gaming machine wherein a plurality of symbols is randomly selected from a predetermined set of symbols and displayed in rows on the display and if a winning combination of symbols results, the machine pays a prize. A triggering event invokes a game feature in which a sprite randomly designates one or more of the symbols displayed on the display to be treated as special symbols for that particular game and a prize is awarded for any winning combinations formed with one or more of the special symbols. Embodiments of the special symbol include a wild card symbol and a scatter symbol.

United States Patent Application No. 20060202415 (Taylor) teaches a method for playing a gaming device where selected bets enable various bonuses. In the preferred embodiment 5 different bonuses are offered depending on credit per line bets, and said bonuses may occur in combination.

United States Patent Application No. 20040097280 (Gauselmann) discloses a video gaming machine displaying an array of symbols. If a triggering event occurs, one or more symbols in the array can be replaced with other symbols such by shifting symbols, exchanging symbols, or by other techniques.

Despite the above referenced prior art, there remains a need for new game features that will stimulate the gaming public. Since it is known that gamblers not only play for the win, but for the anticipation of winning as well, the present invention provides methods that offer multiple stages of anticipation.

### SUMMARY OF THE INVENTION

A video monitor screen is provided on which symbols may be provided for use in a slot symbol game, preferably in a “rows by columns” configuration. A single symbol occupies the area (a frame or panel) defined by the intersection of one row and one column. For instance, in a 5-column by 3-row symbol configuration, there would be 15 symbols displayed in 15 frames. The player makes a wager to play the underlying base game and an additional bet or “side bet” may be required to trigger a random special feature, the said side bet being made before any symbols are spun. A first display of symbols is shown, and if a predetermined combination of symbols is present, a prize may be awarded to the player. After resolving the outcome of the base game, the special feature may randomly or pseudo-randomly be displayed before a new game is initiated, although it may be preferred that the feature is randomly initiated only after a losing event in the base game. (Alternately, the special feature may be offered by receiving a triggering event in the base game.) The special feature is a method for magnifying at least one single symbol in the still displayed completed base game. The at least single symbol is selected by the machine processor and is magnified by at least a factor of 2×, in effect enlarging the said single symbol to overlap and then to fill or occupy at least a 2-column by 2-row area, meaning four frames. The symbol may not be magnified across only a single row or two rows, but must magnify the symbol to fill at least 4 frames extending across at least both two rows and two columns. It is not within the scope of the invention to have the symbol be magnified only across a single column or two columns (without expansion of the symbol into rows), and is less desirable to have the symbol expanded into different factors of rows and columns (i.e., 2 columns×3 rows). The enlarged symbol substitutes for the base game symbols directly underneath, and the enlarged symbol may then be changed into multiple same single symbols (i.e., a symbol magnified to a 3×3 area would be changed into 9 same symbols displayed in the 3×3 area). This new symbol array is then analyzed for wins according to a predetermined paytable, and the player is awarded any prizes if at least a winning symbol combination is present. The gameplay in the present invention offers heightened anticipation for the player. In a first stage, the player anticipates whether or not he will receive the special feature. If so, the player, by already having seen the final symbol display in the base game, is excited to hope that a particularly beneficial symbol will then be selected, adding a second stage of anticipation. In a third stage of anticipation, the player wants the selected symbol to be magnified in an advantageous direction. Lastly, the player roots for a magnification larger than 2×. This multi-stage anticipation intrigues and excites the player, ideally contributing to more time on the machine.

### BRIEF DESCRIPTION OF THE FIGURES

FIG. 1 shows a monitor screen of a slot machine with the results of a first spin.

FIG. 2 shows the same game at a later stage.

FIG. 3 shows the same game at a later stage.

FIG. 4 shows the same game at a later stage.

FIG. 5 shows the same game at a later stage.

FIG. 6 shows the same game at a later stage.

FIG. 7 shows the same game at a final stage.

### DETAILED DESCRIPTION OF THE INVENTION

A slot machine processor and a video monitor screen are provided on which symbols may be provided for use in a slot game. The reels may be positioned in a grid, preferably as a matrix of rows and columns, or may be positioned in other symmetric, asymmetric or random patterns.

The player makes a wager to play the underlying game and an additional bet or “side bet” may be required to trigger a special feature, the said side bet being made before any symbols are spun. The special feature may be initiated by a predetermined trigger in the base game, or alternately it may be a random occurrence after a base game is completed or even after a predetermined sequence of events such as consecutive wins or consecutive losses of a predetermined number of events.

In a preferred embodiment of the present invention, a video slot game is discussed. The game consists of at least two parallel reels or reel areas, the reel setup providing individual symbol areas arranged in rows and columns. A single symbol occupies the area defined by the intersection of one row and one column. For instance, in a 5-column by 3-row symbol configuration, there would be 15 symbols displayed. Predetermined paylines that intersect the symbol areas are available for wagering. Preferably, the video slot game is a 5-reel×3-row arrangement of 15 symbols, and at least 9 paylines are offered. The player chooses the number of paylines upon which to wager, and the number of credits to be wagered on each payline. The total wager (number of paylines times number of credits per payline) may then be augmented by an additional “side bet” wager. The side bet feature enables the player to randomly receive a special feature after an initial array of symbols is spun. Upon making the game wager and preferably the side bet, the machine is activated to play the base game, displaying an initial array of symbols. The paylines of the initial array are analyzed, and any winning symbol combinations are paid according to a predetermined paytable. After resolving the outcome of the base game, the special feature may randomly or pseudo-randomly be displayed before a new game is initiated, although it may be preferred that the feature is randomly initiated only after a losing event in the base game. The special feature is a method for magnifying at least one single symbol in the still displayed completed base game, comprising an indicium displayed over the base game symbol array. The said indicium may be a graphic display of a magnifying glass. The indicium moves across the symbol display until stopping over a single symbol, such as in a single frame or panel. The single symbol is selected by the machine processor and is magnified uniformly along the x and y axis by at least a factor of 2×, in effect enlarging the said single symbol to occupy at least a 2-column by 2-row area. The single symbol may enlarge upward from the upper left corner of the symbol area, upward from the upper right corner of the symbol area, downward from the lower left corner of the symbol area, or downward from the lower right corner of the symbol area, the direction been randomly or pseudo-randomly selected by the processor, but expanding to include at least four (4) panels or frames where symbols would be or are displayed. The symbol may not be magnified across only a single row or rows, nor within only a single column or columns, and preferably not in different factors of rows and columns (i.e., 2 columns×3 rows), or off the symbol array area. The enlarged symbol substitutes for the base game symbols underneath, and the enlarged symbol may then be changed into multiple same single symbols (i.e., a symbol magnified to a 2×2 area would be changed into 4 same symbols displayed in the 2×2 area). This new symbol array is then analyzed for wins according to a predetermined paytable, and the player is awarded any prizes if at least a winning symbol combination is present.

In another preferred embodiment of the present invention, a video slot game is discussed. The game consists of at least two parallel reels or reel areas, the reel setup providing individual symbol areas arranged in rows and columns. A single symbol occupies the area defined by the intersection of one row and one column. For instance, in a 5-column by 5-row symbol configuration, there would be 25 symbols displayed. Predetermined paylines that intersect the symbol areas are available for wagering. The player chooses the number of paylines upon which to wager, and the number of credits to be wagered on each payline. The total wager (number of paylines times number of credits per payline) may then be augmented by an additional “side bet” wager. Upon making the game wager, the machine is activated to play the base game, displaying an initial array of symbols. The paylines of the initial array are analyzed, and any winning symbol combinations are paid according to a predetermined paytable. If a triggering event is present in the initial array, a special feature is initiated. The special feature is a method for magnifying at least one single symbol in the still displayed completed base game, comprising an indicium displayed over the base game symbol array. The said indicium may be a graphic display of a magnifying glass. The indicium moves across the symbol display until stopping over a single symbol. The single symbol may be selected by the machine processor or player and is magnified uniformly along the x and y axis by at least a factor of 2×, in effect enlarging the said single symbol to occupy at least a 2-column by 2-row area. The single symbol may enlarge from the upper left corner of the symbol area, the upper right corner of the symbol area, the lower left corner of the symbol area, or the lower right corner of the symbol area, the direction been randomly or pseudo-randomly selected by the processor. The symbol may not be magnified across only a row or rows, within only a column or columns, or in different factors of rows and columns (i.e., 2 columns×3 rows). The symbol may or may not be magnified beyond the symbol array area. The enlarged symbol substitutes for the base game symbols directly underneath, and the enlarged symbol may then be changed into multiple same single symbols (i.e., a symbol magnified to a 3×3 area within the symbol array area would be changed into 9 same symbols displayed in the 3×3 area). This new symbol array is then analyzed for wins according to a predetermined paytable, and the player is awarded any prizes if at least a winning symbol combination is present.

Both of the aforementioned embodiments may allow for the player to either choose to keep any base game awards and forfeit the special feature opportunity, or to forfeit any base game awards in order to play the special feature.

Those trained in the art will appreciate that these play options are exemplary and are not intended to dictate an exclusive method of play, nor limit or restrict specific gameplay.

Reference to the Figures will assist in further understanding of the practice of the present invention.

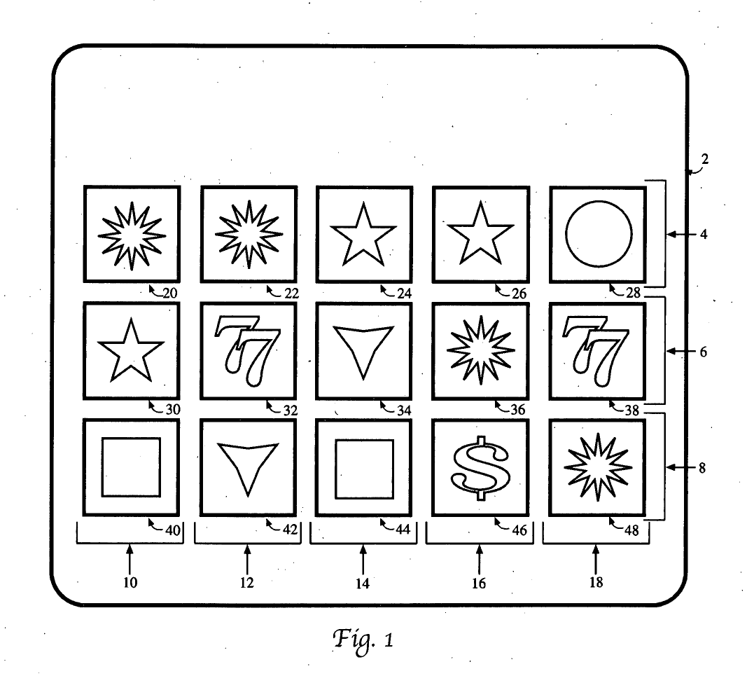

FIG. 1 shows a slot machine monitor screen 2 with the result of the completed spin after the player has wagered to play the base game along with an additional wager for the special feature opportunity. Fifteen individual symbol boxes (20, 22, 24, 26, 28, 30, 32, 34, 36, 38, 40, 42, 44, 46, 48) are arranged in a three-row (4, 6, 8) by five-column (10, 12, 14, 16, 18) matrix.

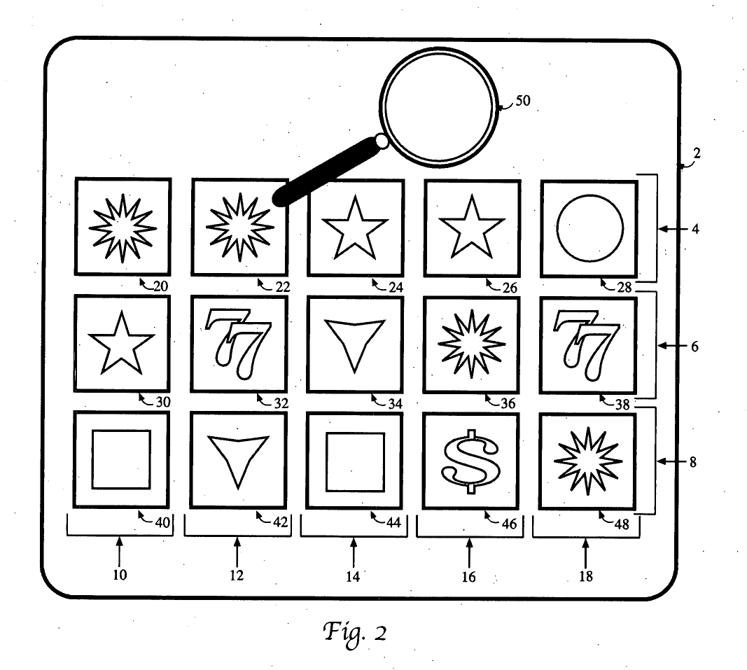

FIG. 2 refers to the game elements shown in FIG. 1 with the random appearance of a special indicium, specifically a magnifying glass 50.

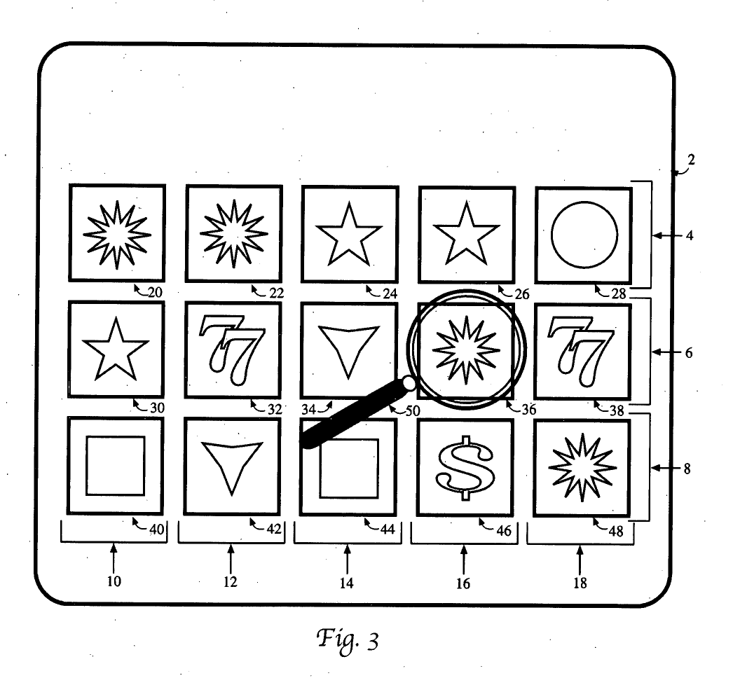

FIG. 3 refers to the game elements shown in FIG. 2 with the magnifying glass 50 “randomly” stopping over the starburst symbol 36.

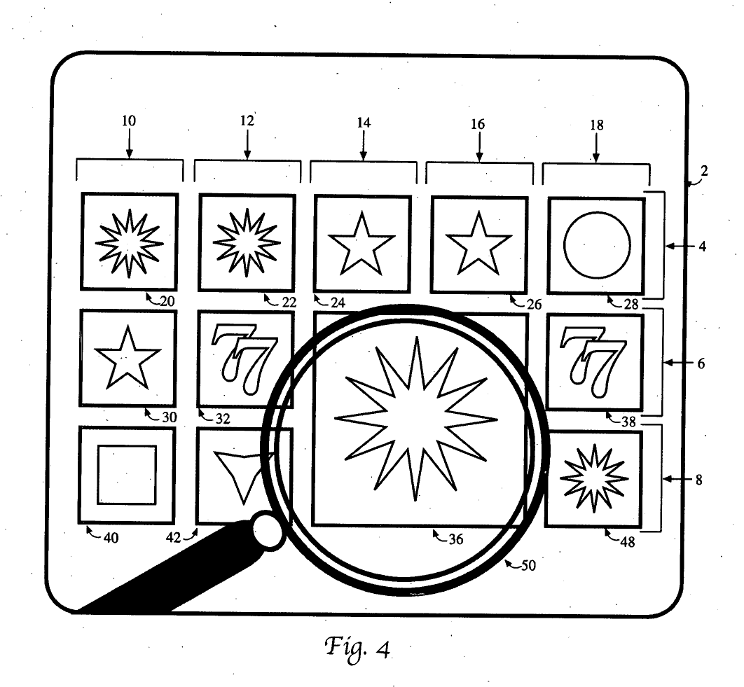

FIG. 4 refers to the game elements shown in FIG. 3 and shows the starburst symbol 36 being enlarged by the magnifying glass 50 in a southwesterly direction to the lower left until it occupies a 2-row by 2-column area.

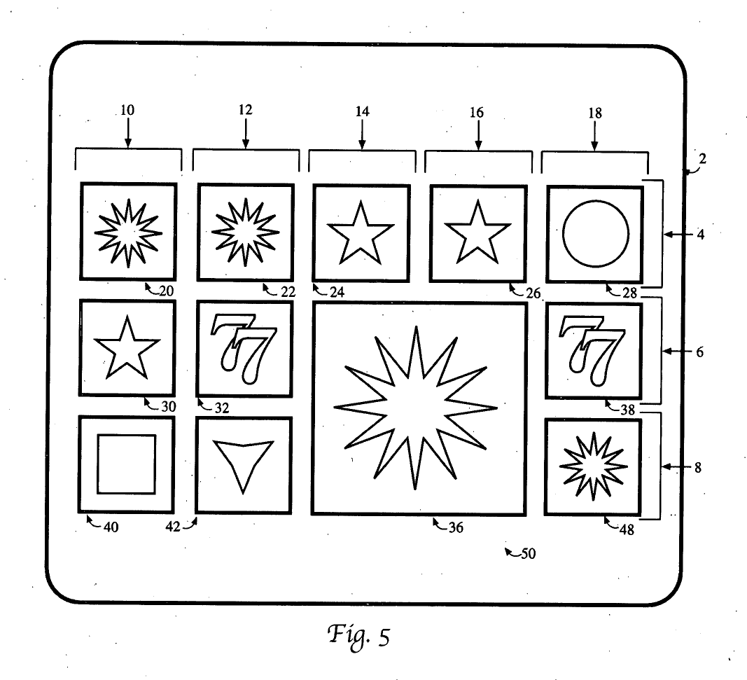

FIG. 5 refers to the game elements shown in FIG. 4 with the magnifying glass deleted and shows the magnified starburst symbol 36 replacing the underlying base game symbols (34, 36, 44, 46 from FIG. 3) in the 2-row by 2-column area.

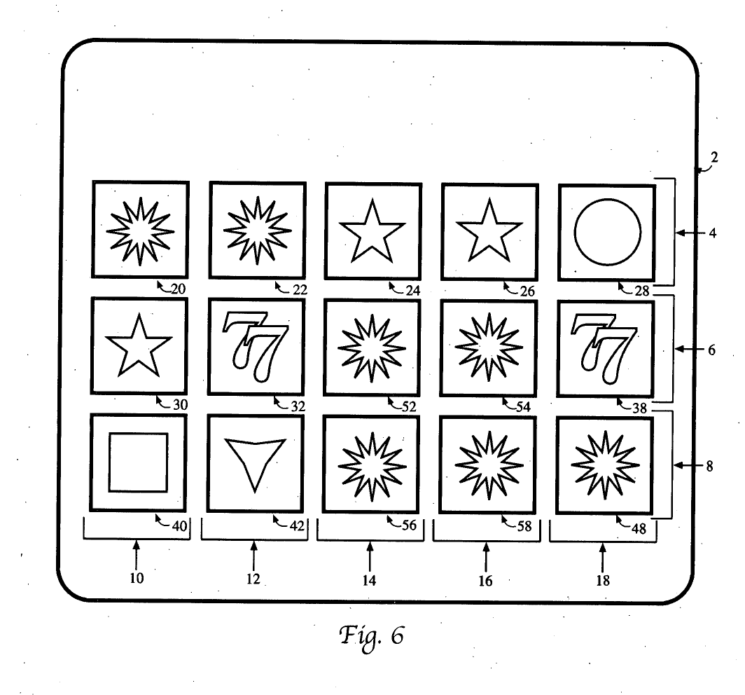

FIG. 6 refers to the game elements shown in FIG. 5 with the magnified starburst symbol 36 being replaced by four single starburst symbols (52, 54, 56, 58).

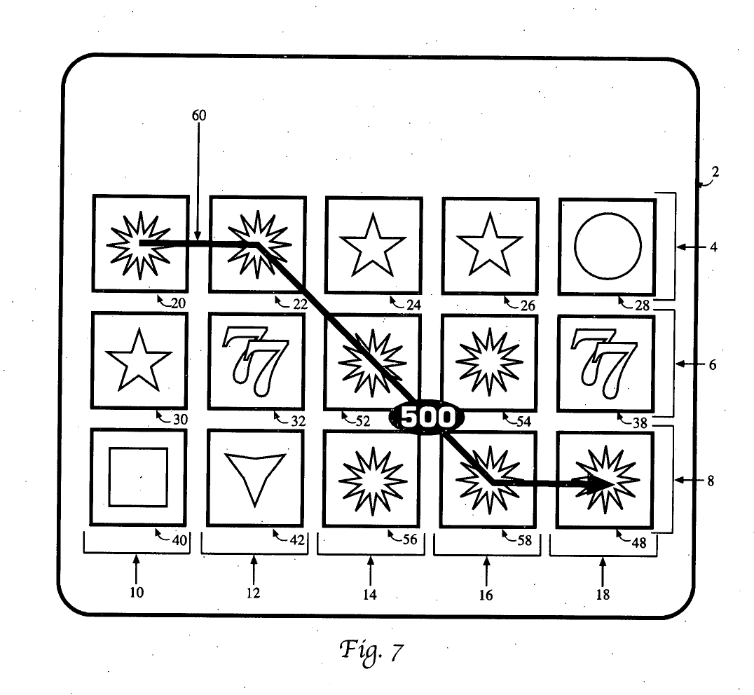

FIG. 7 refers to the game elements shown in FIG. 6 with the appearance of a highlighted payline 60, indicating the win of 500 credits.

The present invention can be implemented using a variety of different processing apparatus. Preferably, the invention is implemented using a computer to determine game operations. A typical computer includes a central processing unit connected to a memory. The computer has connected thereto other devices such as display screen, buttons and/or a touch screen input device, one or more front panel buttons used in the operation of the machine; a coin, credit, token, or card acceptor for allowing a player to place bets; a network card for connecting the computer to an optional central computer, and security system connections. The central computer may be used for accounting, bookkeeping, and/or security purposes, or for downloading new game software or game software upgrades to computer, and/or for controlling the operation of the game via a network. In one optional embodiment, the computer includes a memory having a more permanent first portion in which is stored the software for running games on a CPU. This more permanent memory may be a hard disk read only memory (ROM), erasable programmable read only memory (EPROM), an application specific integrated circuit (ASIC), field programmable gated array (FPGA) or even a feed through a network to a localized or central memory. A thin client network from the central computer or local game computer to the individual gaming device may alternatively be provided. All of these integrated circuit storage means are well known in the art so are not discussed further. The advantage to providing all game logic via a stored program on hard disk, or via network card from a central computer is that a game may quickly and easily be updated, or a different game program be loaded to run on the computer without having to change any integrated circuit chips, such as the ROMs, EPROMs or ASICs. When game software remains on the central computer, it permits games to be played over a local network, or over a remote network which may include the Internet. The memory also has a second portion used in playing the games. The second memory would be typically a random access memory (RAM) with memory locations associated with each of the primary game positions, secondary game positions, secondary game progressives, information display areas and soft buttons on a display. These memory locations store information about the game symbols displayed, the bets placed, winnings, the speed of the game, etceteras. Alternatively, individual game software may not be permanently stored in memory. When a player touches a game selection button, or reel set selection button or control, and a game or reel sets is selected for a game, the request may be transmitted via network or network card to a central computer and the game software is downloaded to the more permanent memory to be used by the CPU to run the game or reel set chosen by the player. This permits central control of the games to be played on specific machines, fast upgrades of game software and easier addition of software for new games.

In a further non-limiting configuration, one or more of the players can be located in separate locations, and the player terminals or hand-held devices or player screens in rooms can be connected to the controller via communication links (e.g., hardwired or wireless). Standard protocols, software, hardware and processor languages may be used in these communication links, without any known limitation. There are hundreds of available computer languages that may be used, among the more common being Ada; Algol; APL; awk; Basic; C; C++; Cobol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; and XML.

Any commercial processor may be used either as a single processor, serial or parallel set of processors in the system. Examples of commercial processors include, but are not limited to Merced™, Pentium™, Pentium II™, Xeon™, Celeron™, Pentium Pro™, Efficeon™, Athlon, AMD and the like.

Display screens may be segment display screen, analog display screens, digital display screens, CRTs, LED screens, Plasma screens, liquid crystal diode screens, and the like.

Although specific examples and specific images have been provided in this discussion, these specifics are intended to be only support for the generic concepts of the invention and are not intended to be absolute limits in the scope of the technology discussed.

What is claimed:

1. A method of playing a video wagering game or bonus event on a video gaming apparatus comprising:
providing a display screen having an initial symbol area comprised of rows X and columns Y defining spaces within which symbols are displayed;
providing at least two distinct paylines in the initial symbol area that are available for wagering;
placing a wager on at least one payline;
providing symbols within the spaces during the play of the game;
providing a special indicium that can virtually move across the initial symbol area, wherein the special indicium can stop over at least one of the underlying symbols in one of the spaces;
wherein the one of the underlying symbols in the one of the spaces is enlarged along both an X row axis and a Y column axis to fill at least two spaces along the X axis and at least two spaces along the Y axis of the initial symbol area;
wherein the enlarged symbol replaces any underlying symbols initially displayed in the X axis and Y axis of the initial symbol area by enlarging of the one of the spaces;
wherein the enlarged symbol is converted into a single same symbol for the replaced underlying symbols to form a final symbol array;
wherein the final symbol array is analyzed for winning symbol combinations along the at least two distinct paylines; and
wherein wagers are resolved for the final symbol array for wagers on the at least two paylines.

2. The method of claim 1 wherein the initial symbol area comprises at least three rows and three columns.

3. The method of claim 2 wherein only one symbol is initially displayed in the intersection of any one row and any one column.

4. The method of claim 1 wherein the special indicium is a magnifying glass symbol.

5. The method of claim 4 wherein the magnifying glass symbol is provided randomly or pseudo-randomly after the initial symbol array is provided.

6. The method of claim 4 wherein the magnifying glass symbol is provided only after a triggering event in the initial symbol array.

7. The method of claim 5 wherein the magnifying glass symbol enlarges the underlying symbol by 2×, to form a 2-row by 2-column segment of replaced symbols of the initial symbol area.

8. The method of claim 6 wherein the magnifying glass symbol enlarges the underlying symbol by 2×, to form a 2-row by 2-column segment of replaced symbols of the initial symbol area.

9. The method of claim 5 wherein the magnifying glass symbol enlarges the underlying symbol by at least 3×to form at least a 3-row by 3-column segment of replaced symbols of the initial symbol area.

10. The method of claim 6 wherein the magnifying glass symbol enlarges the underlying symbol by at least 3×to form at least a 3-row by 3-column segment of replaced symbols of the initial symbol area.

11. The method of claim 7 wherein the enlarged symbol is displayed as four separate same symbols in a 2-row by 2-column format.

12. The method of claim 8 wherein the enlarged symbol is displayed as four separate same symbols in a 2-row by 2-column format.

13. The method of claim 9 wherein the enlarged symbol is displayed as nine separate same symbols in a 3-row by 3-column format.

14. The method of claim 10 wherein the enlarged symbol is displayed as nine separate same symbols in a 3-row by 3-column format.

15. A video gaming device that contains a video display area and a processor, the processor being able to execute software that enables play of the video wagering game or bonus game of claim 1.
